(19) United States
(12) Patent Application Publication
(10) Pub. No.: US 2015/0086815 A1
(43) Pub. Date: Mar. 26, 2015

(54) METHOD FOR CHECKING A SLEEP MODE OF A CELL SUPERVISION CIRCUIT AND LITHIUM-ION RECHARGEABLE BATTERY

(71) Applicant: Robert Bosch GmbH, Stuttgart (DE)

(72) Inventors: Joerg Christoph Wilhelm, Stuttgart (DE); Volkher Hofmann, Kirchheim/Teck (DE); Holger Wetzel, Tubingen (DE)

(21) Appl. No.: 14/495,539

(22) Filed: Sep. 24, 2014

(30) Foreign Application Priority Data
Sep. 25, 2013 (DE) 10 2013 219 282.7

(51) Int. Cl. H01M 10/42; H01M 10/0525

(52) U.S. Cl. CPC H01M 10/425; H01M 10/0525; H01M 2220/20; H01M 2010/4271
USPC 429/50; 429/61

(57) ABSTRACT

Checking a sleep mode of a cell supervision circuit of a lithium-ion rechargeable battery having at least one electrochemical cell, while a sleep mode is set by a control device of the rechargeable battery for the cell supervision circuit, wherein, according to the method, the sending of a sleep command of the control device to the cell supervision circuit is connected to a confirmation request to the cell supervision circuit, and, in the event of non-receipt of a confirmation from the cell supervision circuit, the control device sends the sleep command and/or the confirmation request again after a time interval.

### BACKGROUND OF THE INVENTION

The present invention relates to a method for checking a sleep mode of a cell supervision circuit of a lithium-ion rechargeable battery having at least one electrochemical cell. The invention also relates to a lithium-ion rechargeable battery.

A rechargeable battery is typically used as energy source in electrically driven vehicles. Lithium-ion rechargeable batteries are often used since these have the largest energy density available to date with the lowest weight. However, said rechargeable batteries are very sensitive with respect to overcharging and also exhaustive discharge. In the case of overcharging above a particular voltage value per cell, usually about 4.25 V, the cell becomes unstable and a self-amplifying heating process (thermal runaway) can be initiated. Discharging below a particular threshold also encourages adverse chemical processes in the cell which lead to irreversible damage of said cell. For this reason, there is a rechargeable battery management system which, by means of a control device of the rechargeable battery and cell supervision circuits on individual cells of the rechargeable battery, often on all of the cells, monitors the cell voltages and can be involved in triggering countermeasures. By way of example, over- and undercharging are suppressed by opening a main switching device which may comprise, for example, one or more charging or main load contactors. This is referred to as exhaustive discharge protection. During operation of an electrically driven vehicle, a situation may occur in which the installed rechargeable battery is exhausted by the driving operation, for example as a result of relatively long diversions, increased energy consumption, faulty operation of a controlled charging station or the like. Said exhaustion of the rechargeable battery is expressed in that a low voltage threshold of one or more cells is reached, which can be detected by means of the cell supervision circuits connected to the cells and upon which the exhaustive discharge protection is activated. It is disadvantageous in this case that, even if the exhaustive discharge protection engages, that is to say the main switching device to all external consumers is open, the power supply of the cell supervision circuits is still maintained under certain conditions, for example in the case of an accident with mechanical damage to the battery control electronics, short-circuits caused by electromigration or software errors in the rechargeable battery management system. However, the cell supervision circuits are not part of the external consumers, but rather they remain connected to the respective electrochemical cells, even if, for example, a main contactor is open. Usually, the cell supervision circuits are not transferred into their sleep mode by the exhaustive discharge protection but rather by means of a sleep command, which can fail. In this situation, the cell supervision circuits still consume current from the rechargeable battery. Particularly when this takes place over a relatively long period of time, there is an acute danger of exhaustive discharge, especially as the rechargeable battery may already be in a state of maximum permissible discharge anyway after a relatively long driving operation.

### SUMMARY OF THE INVENTION

According to the invention, a method is proposed by virtue of which it is possible to check whether cell supervision circuits are actually in a sleep mode in which their power supply is at least partially disconnected. The cell supervision circuits are usually set into the sleep mode by the control device when the electrically driven vehicle is switched off or in the case of another event. In order to check whether the cell supervision circuits have performed the sleep command, the control device sends a confirmation request to the cell supervision circuits. This can take place at the same time as or immediately after the sending of the sleep command. In addition, it is conceivable that the sending of a sleep command automatically includes a confirmation request. The automatic sending of a confirmation when a sleep command is received can accordingly be provided in the cell supervision circuit. Then, the control device checks whether a confirmation in response to the confirmation request or the sleep command has arrived from the cell supervision circuits. In the event of non-receipt, the control device sends the sleep command and/or the confirmation request again after a time interval has passed. The confirmation signal can be received, for example, via a CAN bus. The sleep command and/or the confirmation request can also be sent via the same bus. Usually, the sleep command and, possibly, the confirmation request go to a plurality of cell supervision circuits. These cell supervision circuits usually belong to a plurality of cells which can be a rechargeable battery pack or a part thereof.

In one embodiment of the method, the control device sends the sleep command and/or the confirmation request repeatedly until it receives a confirmation from the cell supervision circuit to which the sleep command/the confirmation request was sent. In this way, it can be determined that and, optionally also when, a transfer into the sleep mode has taken place.

In another embodiment, the control device itself goes into a sleep mode when it has received a confirmation from the cell supervision circuit. If many cell supervision circuits are set into the sleep mode by the control device, the control device preferably goes into its sleep mode when a confirmation has been received from the last cell supervision circuit of which the confirmation was outstanding.

In another embodiment of the method, the external consumers of the rechargeable battery are electrically isolated from the rechargeable battery while the method according to the invention, or an embodiment thereof, is performed. In order to disconnect the external consumers, a main switching device of the rechargeable battery is opened. Opening of the main switching device means that usually no operating state exists, which can typically last a relatively long time. Therefore, the risk of discharging of the rechargeable battery through the current consumption of the cell supervision circuits in this state is particularly high.

In another embodiment of the method, a disconnection signal is sent to a user as a response to the main switching device being opened. If the main switching device was actively opened as a result of a critically low cell voltage for all cells, then an empty state disconnection signal is preferably sent to the user. The user can be, for example, a vehicle driver of an electrically driven vehicle. The disconnection signal can be, for example, a light signal or a tone signal which can be signaled to the user, for example, on a vehicle key, on a vehicle instrument or on a text display in/on the vehicle. In the case of an empty state disconnection signal, by way of example, the text “charge immediately” or “charge urgently” or a light signal or audible signal with corresponding meaning or the like can be output.

In another embodiment of the method, the number of sleep commands which have been sent to a cell supervision circuit by the control device is stored. Alternatively or in addition, the number of confirmation requests can be counted. The cell supervision circuit can be set up to send a confirmation in response to a sleep command. In this case, a special confirmation request can be omitted. The counting can be performed, for example, by the control device, which can use the hardware of a microcontroller and appropriate software or can take place using specific flip-flops provided for this purpose. The counter result can be stored in a RAM.

In another embodiment of the method, a compulsory disconnection of a cell supervision circuit is effected when a predefined number of sleep commands sent thereto has been ineffective. This is determined by no confirmation entering after said number of sleep commands and/or confirmation requests. The connection between the cell supervision circuits and their cells is equipped with an interruption device which makes it possible, in response to a command from the control device, to prevent a flow of current from the cell into the cell supervision circuit. The interruption device can have, for example, a level-controlled or edge-controlled input by means of which the flow of current can be interrupted or restored. Said interruption device is embodied, for example, as a mechanical or electronic switch or the like. Alternatively, the interruption device can also be designed to be smart and can react to a command from the control device. The activation and deactivation of the interruption device is preferably independent of the communication or reaction of the cell supervision circuit. Preferably, the interruption unit is opened after four unsuccessful sleep commands and/or confirmation requests. In addition to the supply lines, measuring lines between the cell supervision circuit and its cell can also be interrupted by the interruption device. If the cell is part of a cell module, connections between the cell supervision circuit and the cell module can also be separated.

In another embodiment of the method, a user of the rechargeable battery receives notification about a compulsory disconnection of a cell supervision circuit. The notification can be displayed to said user, for example, by means of a display in the vehicle, preferably on the dashboard or on the key of the vehicle or the like. Preferably, a text is displayed on a display capable of outputting text. The display can be effected by the control device. By means of the notification, the user can be prompted to notify a workshop, an emergency service or the like of their location in order to have the vehicle towed away, if appropriate, and possibly also to have the cells checked for damage.

In another embodiment of the method, a receiver receives a compulsory disconnection signal when said receiver is not the current user of the rechargeable battery. This can be, for example, a workshop, an emergency service, the manufacturer of the rechargeable battery, a vehicle manufacturer, the fire service or the like. Correspondingly, the control device has the option of actuating a transmission device by means of which the compulsory disconnection signal can be sent to its receiver. The transmission device can be arranged in an electrically operable vehicle at another point than the control device. The compulsory disconnection signal can be sent via a mobile telephone network.

In another embodiment of the method, in the case of multiple performances of the logic loop which comprises sending the sleep command, receiving the confirmation and renewed sending of the sleep command after a time interval in the event of non-receipt of the confirmation, the time interval will be varied; in particular, the time interval can be shortened with each new sending of the sleep command.

In a further aspect of the present invention, a lithium-ion rechargeable battery is proposed, which has a control device, a cell and a cell supervision circuit, wherein the cell supervision circuit monitors the cell and is connected to said cell via measuring and/or power supply lines. It is proposed that a lithium-ion rechargeable battery of this type performs a method according to embodiments of the invention.

### BRIEF DESCRIPTION OF THE DRAWINGS

Two exemplary embodiments of the invention are described in detail below with reference to the appended drawings, in which:

FIG. 1 is a schematic illustration of a method sequence of a first embodiment of the method according to the invention, and

FIG. 2 is a schematic illustration of a flow chart of a second embodiment of the method according to the invention.

### DETAILED DESCRIPTION

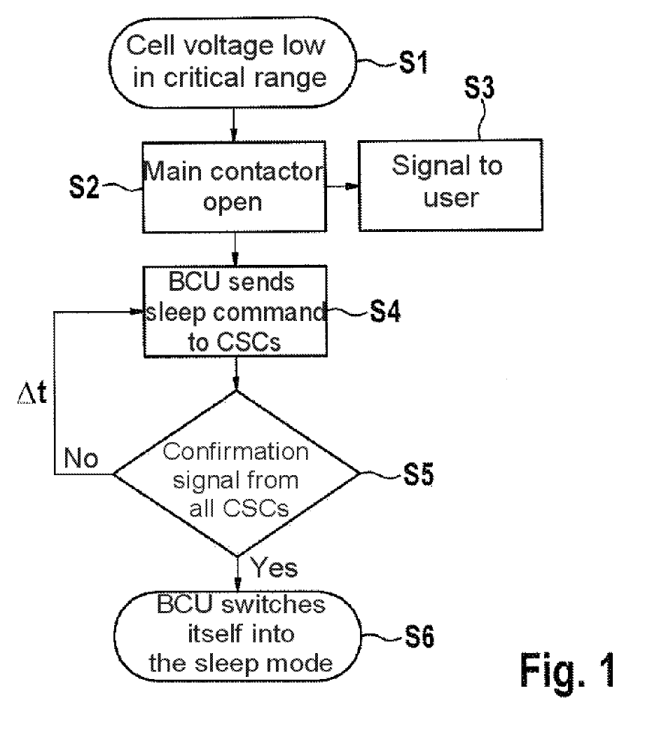

FIG. 1 schematically shows the sequence of a method for checking a sleep mode of a cell supervision circuit of a lithium-ion rechargeable battery. The cell supervision circuit is connected to a cell of the rechargeable battery by means of power-supply and/or measuring connections in order to monitor the state of said cell, in particular the cell voltage thereof. Information can be sent from the cell supervision circuit via signal connections to a control device of the rechargeable battery, which battery monitors the state of the rechargeable battery by means of the cell supervision circuits. The control device can send a sleep command to the cell supervision circuits in order to transfer same into a sleep mode in which the current consumption thereof is reduced or prevented. Said sleep mode can prevent the supply current for the cell supervision circuits from reducing the state of charge of the cells monitored by said cell supervision circuits. Such a state can arise, for example, if an electrically operable vehicle in which the rechargeable battery is installed has consumed the energy in the battery up to a critical threshold. This is detected by the cell supervision circuits in a step S1. A cell voltage of one or more cells in a critically low range leads, in the sequence of the method, to a main contactor, by means of which the rechargeable battery can be isolated from its external consumers, being opened in a step S2. However, the isolation of the external consumers does not cause the supply of the cell supervision circuits from the rechargeable battery or measuring lines between cell supervision circuits and their monitored cell to be interrupted. Thus, it is possible for current still to flow from the rechargeable battery through cell supervision circuits. In a step S3, a disconnection signal is sent to a user of the rechargeable battery. In order to prevent further current consumption by the cell supervision circuits, the control device (BCU, battery control unit) sends a sleep command to the cell supervision circuits (CSCs) in a step S4 in order to transfer same into the sleep mode. In a step S6, the control device expects a confirmation signal from each of the cell supervision circuits to which a sleep command was sent. If no confirmation signal is received at the control device, said control device repeats the sleep command to the cell supervision circuits after a time interval Δt. In the flow chart, the control is therefore given back to the step S5. The method then continues with the step S6 in which the control device awaits confirmation signals from one or more cell supervision circuits which have not yet responded. This loop with delayed feedback in the event of an absent confirmation signal of at least one cell supervision circuit and renewed sending of the sleep command, that is to say the steps S5 and S6 and their logic connections, represents an infinite loop which can be broken by confirmation signals from all cell supervision circuits from which a confirmation signal is expected arriving. If this criterion is fulfilled, the control device switches itself into the sleep mode in a step S7. In this way, the current consumption is further reduced.

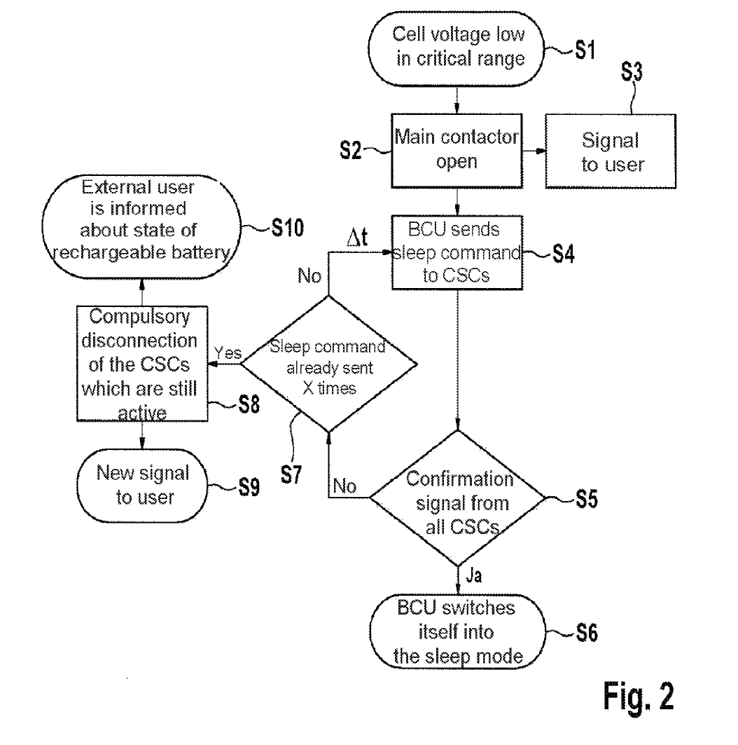

FIG. 2 schematically illustrates the sequence of another embodiment of the method according to the invention for checking cell supervision circuits. The method sequence is largely identical to the method sequence illustrated in FIG. 1. Identical method steps are denoted with the same reference signs and are not separately explained again. In contrast to the method illustrated in FIG. 1, a further step S7 is intermediately connected in the feedback loop from the step S5 to the step S4. In the embodiment of the method illustrated in FIG. 2, the number of sleep commands which the control device has sent to the cell supervision circuits is stored. In step S7, it is checked how often the sleep command has already been sent. If the number of sendings does not exceed a predefined limit value X, the method transfers again from step S7 to step S4 after a wait time At, as a result of which the loop comprising the method steps S4, S5 and S7 is closed. The wait time At can alternatively also be provided between the step S5 and the step S7. If the sleep command has been sent X times, however, the method transfers to the step S8 in which a compulsory disconnection of cell supervision circuits which are not yet in the sleep mode is effected. These are the cell supervision circuits from which a confirmation signal was expected but was not received. The compulsory disconnection can be effected via an interruption device by means of which a power supply between the rechargeable battery and a cell supervision circuit can be interrupted. The interruption device can be actuated from the control device, preferably independently of other processes. Preferably, signal lines which are independent of the normal communication between the control device and the cell supervision circuits are provided for said actuation. In another step S9, a compulsory disconnection signal is sent to a user of the rechargeable battery after compulsory disconnection has occurred. Said user is thus informed that a cell supervision circuit could not be transferred into the sleep mode. In a step S10, an external receiver, for example an emergency service, the fire service, the battery manufacturer, a workshop or a vehicle manufacturer of a vehicle in which the rechargeable battery is installed is informed about the state of the rechargeable battery.

1. A method for checking a sleep mode of a cell supervision circuit of a lithium-ion rechargeable battery having at least one electrochemical cell, while a sleep mode is set by a control device of the rechargeable battery for the cell supervision circuit, the method comprising:
sending a sleep command from the control device to the cell supervision circuit;
sending a confirmation request from the control device to the cell supervision circuit; and
in the event of non-receipt by the control device of a confirmation from the cell supervision circuit, resending the sleep command, the confirmation request, or both after a time interval.

2. The method according to claim 1, wherein the control device sends the sleep command, the confirmation request, or both until it receives a confirmation from the cell supervision circuit.

3. The method according to claim 1, wherein the control device goes into a sleep mode after it has received the confirmation from the cell supervision circuit.

4. The method according to claim 1, wherein the method is performed while a main switching device of the lithium-ion rechargeable battery is open, it being possible for electric current flow from and to the lithium-ion rechargeable battery to be interrupted by said main switching device.

5. The method according to claim 4, wherein a disconnection signal is sent to a user of the lithium-ion rechargeable battery as a response to the main switching device being opened.

6. The method according to claim 1, wherein the number of sleep commands, confirmation requests, or both to the cell supervision circuit is stored.

7. The method according to claim 6, wherein, after a predefined number of sleep commands, confirmation requests, or both in response to which no confirmation has been received, a compulsory disconnection of the cell supervision circuit is effected at the cell supervision circuit.

8. The method according to claim 7, wherein the user of the lithium-ion rechargeable battery receives a compulsory disconnection signal that informs said user about the compulsory disconnection of the cell.

9. The method according to claim 7, wherein a receiver who is not the user of the lithium-ion rechargeable battery receives a compulsory disconnection signal.

10. A lithium-ion rechargeable battery having a control device, a cell and a cell supervision circuit connected to the cell, wherein the lithium-ion rechargeable battery performs a method according to claim 1.
